(19) United States
(12) Patent Application Publication
(10) Pub. No.: US 2014/0108285 A1
(43) Pub. Date: Apr. 17, 2014

(54) SYSTEM AND METHOD FOR AN INFLUENCED BASED STRUCTURAL ANALYSIS OF A UNIVERSITY

(71) Applicant: SRM INSTITUTE OF SCIENCE AND TECHNOLOGY, West Mambalam (IN)

(72) Inventors: Sridhar Varadarajan, Bangalore (IN); Srividya Gopalan, Bangalore (IN); Preethy Iyer, Bangalore (IN)

(73) Assignee: SRM INSTITUTE OF SCIENCE AND TECHNOLOGY, West Mambalam (IN)

(21) Appl. No.: 14/054,297

(22) Filed: Oct. 15, 2013

Related U.S. Application Data
(63) Continuation-in-part of application No. 12/873,715, filed on Sep. 1, 2010, now abandoned.

(30) Foreign Application Priority Data
May 6, 2010 (IN) 1269/CHE/2010

(51) Int. Cl. G06Q 50/20; G06Q 10/00

(52) U.S. Cl. CPC G06Q 50/20; G06Q 10/00
USPC 705/326

(57) ABSTRACT

An educational institution (also referred as a university) is rich with multiple kinds of data: students, faculty members, departments, divisions, and at university level. Relating and correlating this data at and across various levels help in obtaining a perspective about the educational institution. A structural representation captures the essence of all of the relationships in a unified manner and an important aspect of the relationship is the so-called “influence factor.” This factor indicates influencing effect of an entity over another entity, wherein the entities are a part of the structural representation. Given such a structural representation, a system and method that propagates the influence factors of the entities to arrive at a stable representation from the point of view of influences is discussed.

### RELATED APPLICATIONS

This application is a continuation-in-part of and claims priority to U.S. patent application Ser. No. 12/873,715 filed on Sep. 1, 2010 entitled, “System and Method For An Influence Based Structural Analysis of a University” which also claims priority under 35 USC 119 of Indian Application No. 1269/CHE2010, filed on May 6, 2010 and incorporates U.S. patent application Ser. No. 12/873,715 herein by reference in its entirety.

### FIELD OF THE INVENTION

The present invention relates to the influence based structural analysis in general, and more particularly, automated analysis of structural representations. Still more particularly, the present invention relates to a system and method for automatic influence based structural analysis of a model graph associated with a university.

### BACKGROUND OF THE INVENTION

An educational institution (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical information, and Significant milestones, of the university; (b) Profile of the Labs, Departments, and Divisions; (c) Profile of the Faculty members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. Prospective students, candidates for exploring opportunities within the university, and funding agencies look towards this kind of portal to obtain information about and assess the university. While there are both objective and subjective measures for the assessment, the visitors to the portals would be more than satisfied if some information about these assessments is provide as part of the portals. For example, the students use this assessment information as part of the university portal to get a better understanding of the university they are exploring to enroll. Similarly, a funding agency gets a better picture of the university that they are planning to fund.

### DESCRIPTION OF RELATED ART

U.S. Pat. No. 7,162,431 to Guerra; Anthony J. (Hartsdale, N.Y.) for “Educational institution selection system and method” (issued on Jan. 9, 2007 and assigned to Turning Point for Life, Inc. (Hartsdale, N.Y.)) describes a system, method, and computer program product for selecting an educational institution, including determining selection criteria for an educational institution, including a location of the educational institution, a type and size of the educational institution, and an admission selectivity of the educational institution; and generating a list of one or more recommended schools satisfying the selection criteria, wherein the recommended schools satisfy predetermined freshman retention rates and graduation rates.

U.S. Pat. App. 20060265237 titled “System and method for ranking academic programs” by Martin; Lawrence B.; (Stony Brook, N.Y.); Olejniczak; Anthony J.; (Leipzig, DE) filed on Mar. 27, 2006 describes a computer-implemented method for ranking a plurality of academic programs includes receiving a plurality of records corresponding to the plurality of academic programs, respectively, combining elements of the plurality of records to determine respective z-scores according to a predetermined metric, and ranking the plurality of academic programs according to the respective z-scores.

“Operators for Propagating Trust and their Evaluation in Social Networks” by Hang; Chung-Wei, Wang; Yonghong, and Singh, Munindar (appeared in International Conference on Autonomous Agents, Proceedings of The 8th International Conference on Autonomous Agents and Multiagent Systems—Volume 2 (2009)) describes an algebraic approach for the propagation of trust in a multiagent system.

“Stability of Graphs” by Demir; Bunyamin, Deniz; Ali, and Kocak; Sahin (appeared in The EIectronic Journal of Combinatorics Vol. 16, No. 6 (2009)) describes a notion of graph stability to establish equivalence between two positively weighted graphs.

“Max-product for maximum weight matching: convergence, correctness and LP duality” by Bayati; Mohsen, Shah; Devavrat, and Sharma; Mayank (appeared in IEEE transactions on Information Theory, Vol. 54, No. 3, (2008)) describes, max-product “belief propagation”, an iterative, message-passing algorithm for finding the maximum a posteriori assignment of a discrete probability distribution specified by a graphical model.

The known systems do not address the issue of systematically utilizing the assessment at the elemental level and inter-element influences to assess an educational institution at various aggregated component levels. The present invention provides with a system and method for influence based structural analysis of an educational institute.

### SUMMARY OF THE INVENTION

The primary objective of the invention is to assess an educational institute at elemental and component level.

One aspects of the present invention is to obtain a university model graph of an educational institute that provides the structural representation of the educational institution.

Another aspect of the invention is to capture and utilize the influences at elemental level between elements of the university model graph.

Yet another aspect of the invention is to compute the assessment at elemental levels.

Another aspect of the invention is to propagate the elemental influences to assess at multiple aggregated component levels.

Yet another aspect of the invention is to define the university model graph as comprising of multiple nodes representing the educational institution at elemental and component levels.

Another aspect of the invention is to define the assessment at elemental levels as base score of the nodes associated with the university model graph.

Yet another aspect of the invention is to compute the best possible score called as peak score associated with the nodes of the university model graph.

In a preferred embodiment the present invention provides a system for structural analysis of a university to determine a plurality of assessments of said university at a plurality of levels, wherein said university comprises of a plurality of entities and said plurality of levels comprises of an element level and a component level, said system comprises:
means for obtaining of a university model graph of said university, wherein said university model graph comprises of a plurality of abstract nodes, a plurality of nodes, a plurality of abstract edges, and a plurality of edges, with each abstract node of said plurality of abstract nodes corresponding to an entity of said plurality of entities and each abstract node of said plurality of abstract nodes is associated with a model of a plurality of models, and a node of said plurality of nodes is connected to an abstract node of said plurality of abstract nodes through an abstract edge of said plurality of abstract edges, wherein said node represents an instantiation of an entity associated with said abstract node and said node is associated with an instantiated model, a base score, a present score, and a peak score, wherein said instantiated model is based on a model associated with said abstract node, and said base score is computed based on said instantiated model and is a value between 0 and 1, and a source node of said plurality of nodes is connected to a destination node of said plurality of nodes by a directed edge of said plurality of edges and said directed edge is associated with an influence factor, wherein said influence factor is a value between −1 and +1; (Refer to FIGS. 2, 2a, 2b, 3, and 4)
means for constructing a plurality of edge chains based on said university model graph;
means for performing of epsilon propagation based on said university model graph and said plurality of edge chains;
means for performing of core iteration based on said epsilon propagation and said plurality of edge chains;
means for determining of a characteristic value of a plurality of characteristic values based on said plurality of edge chains;
means for computing of a plurality of peak scores associated with said plurality of nodes of said university model graph based on said plurality of characteristic values; and
means for determining of said plurality of assessments based on said plurality of peak scores. (BASED ON FIGS. 6, 6a, and 6b)

### BRIEF DESCRIPTION OF THE DRAWINGS

FIG. 1 provides a typical assessment of a university.

FIG. 1a provides a partial list of entities of a university.

FIG. 2 depicts some concepts related to University Model Graph (UMG).

FIG. 2a provides an illustrative UMG.

FIG. 2b provides a brief description of the illustrative UMG.

FIG. 3 provides a brief about the notion of influence factor.

FIG. 4 describes information related to influence propagation and stability.

FIG. 5 describes an approach for UMG traversal and the core iteration.

FIG. 5a provides additional information related to the approach for UMG traversal and core iteration.

FIG. 6 provides an approach for UMG optimization.

FIG. 6a provides an assessment of an EI based on a UMG.

FIG. 6b provides an approach for EI assessment.

FIG. 7 depicts a portion of an Illustrative UMG.

FIG. 7a provides a portion of illustrative Base Scores.

FIG. 7b provides a portion of an illustrative Influence Matrix.

FIG. 7c depicts illustrative assessment based on Peak Score Computation.

FIG. 7d depicts additional results related to illustrative assessment based on Peak Score Computation.

FIG. 8 provides an illustrative University Assessment System.

FIG. 8a depicts an illustrative student data.

FIG. 8b provides an illustrative UMG of student data.

FIG. 8c provides an illustrative node Peak Score structure.

FIG. 9 provides another approach for Peak Score computation.

FIG. 9a provides additional information related to Peak Score computation approach.

FIG. 9b provides some more information related to Peak Score computation approach.

FIG. 10 provides an illustrative UMG from the perspective of a student.

FIG. 10a provides an illustrative base score and influence values.

FIG. 10b depicts illustrative peak score related computational results.

FIG. 10c provides another illustrative UMG from the perspective of a student.

FIG. 10d provides another illustrative base score and influence values.

FIG. 10e depicts another illustrative peak score related computational results.

FIG. 10f provides yet another illustrative UMG from the perspective of a student.

FIG. 10g provides yet another illustrative base score and influence values.

FIG. 10h depicts yet another illustrative peak score related computational results.

FIG. 11 provides an illustrative peak score computation in Python programming language.

FIG. 11a provides addition information related to peak score computation in Python programming language.

### DETAILED DESCRIPTION OF THE PREFERRED EMBODIMENTS

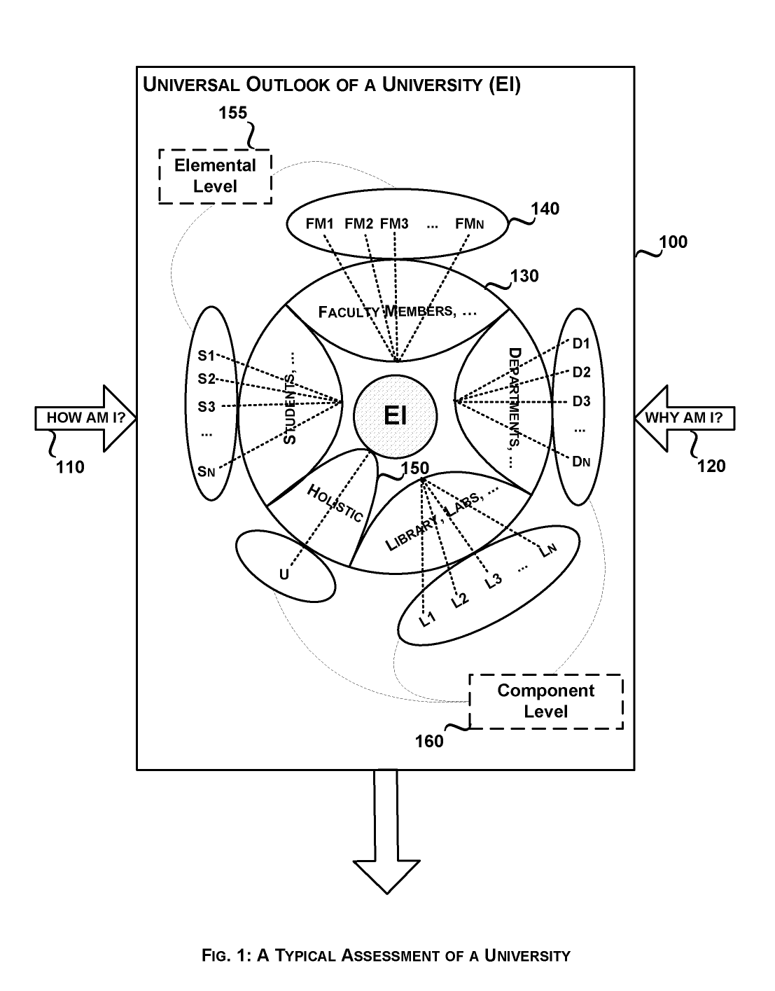

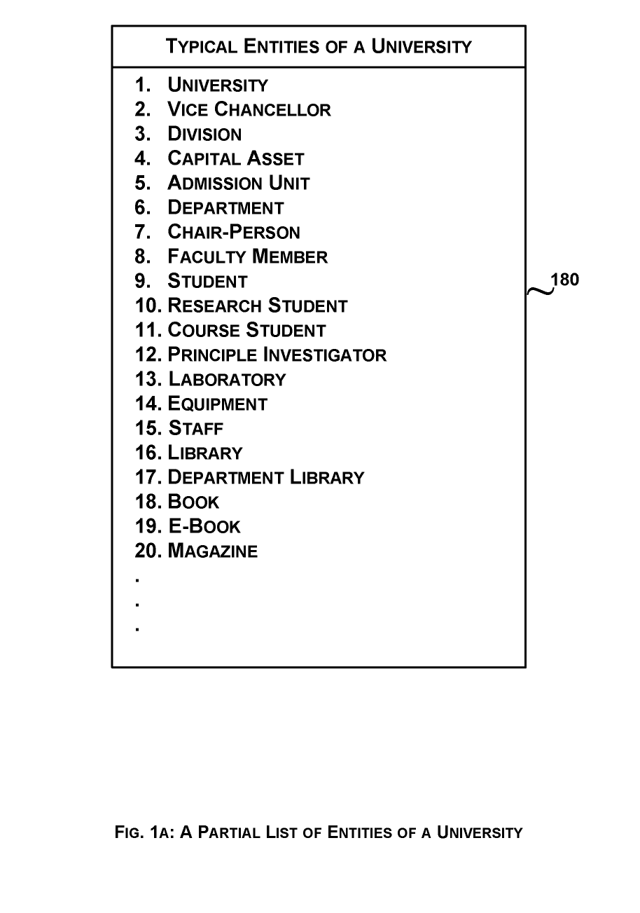

FIG. 1 provides a typical assessment of a university. An Educational Institution (EI) or alternatively, a university, is a complex and dynamic system with multiple entities and each interacting with multiple of other entities. The overall characterization of the EI is based on a graph that depicts these multi-entities multiple relationships. An important utility of such a characterization is to assess the state and status of the EI. What it means is that, in the context of the EI, it is helpful if every of the entities of the EI can be assessed. Assessment of the EI as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the EI and in any EI, th ere are several instances of this entity that are associated with the students of the EI. The assessment can be at STUDENT level or at S1 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members of FM1, FM2, . . . , FMn (140) of the EI. The holistic assessment (150) helps answer How and Why at university level. Observe that there are two distinct kinds of entities: One class of entities is at the so-called “EIement” level (155)—this means that this kind of entities are at the atomic level as for as the university domain is concerned. On the other hand, there is a second class of entities at the so-called “Component” level (160) that accounts for remaining entities of the university domain all the way up to the University level.

FIG. 1a depicts a partial list of entities of a university. Note that a deep domain analysis would uncover several more entities and also their relationship with the other entities (180). For example, RESEARCH STUDENT is a STUDENT who is a part of a DEPARTMENT and works with a FACULTY MEMBER in a LABORATORY using some EQUIPEMENT, the DEPARTMENT LIBRARY, and the LIBRARY.

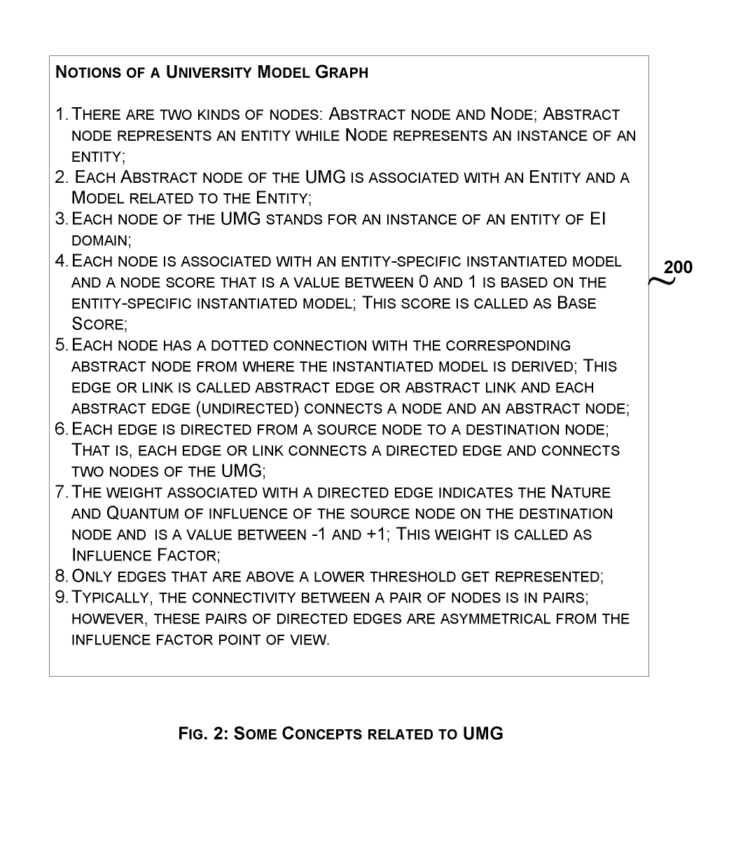

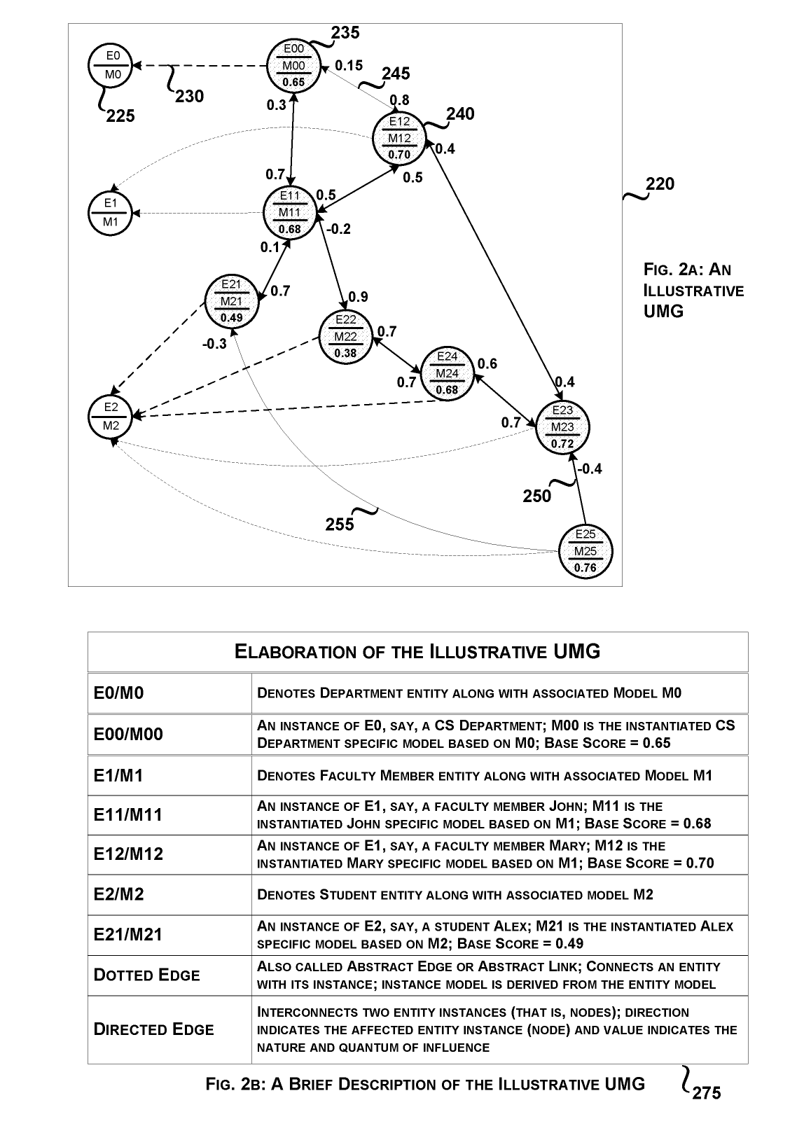

FIG. 2 provides some concepts related to University Model Graph (UMG) and means for obtaining UMG. A UMG is a typical graph that captures and relates the entities of the EI domain (200). Note that for the purposes of the present invention, a UMG, as described below, related to a university under consideration is available for structural analysis.

### Notions of a University Model Graph

1. There are two kinds of nodes: Abstract node and Node; Abstract node represents an entity while Node represents an instance of an entity;
2. Each Abstract node of the UMG is associated with an Entity and a Model related to the Entity;
3. Each node of the UMG stands for an instance of an entity of EI domain;
4. Each node is associated with an entity-specific instantiated model and a node score that is a value between 0 and 1 is based on the entity-specific instantiated model; This score is called as Base Score;
5. Each node has a dotted connection with the corresponding abstract node from where the instantiated model is derived; This edge or link is called abstract edge or abstract link and each abstract edge (undirected) connects a node and an abstract node;
6. Each edge is directed from a source node to a destination node; That is, each edge or link connects a directed edge and connects two nodes of the UMG;
7. The weight associated with a directed edge indicates the Nature and Quantum of influence of the source node on the destination node and is a value between −1 and +1; This weight is called as Influence Factor;
8. Only edges that are above a lower threshold get represented;
9. Typically, the connectivity between a pair of nodes is in pairs; however, these pairs of directed edges are asymmetrical from the influence factor point of view.

More particularly, there are several instances of each of the entities of the EI domain and the UMG captures the inter-relationship among the instance of these entities. Please note that in the sequel edge and link are used interchangeably.

FIG. 2a depicts an Illustrative UMG. The illustrative UMG (220) has several nodes: an abstract node (225) has a dotted link (abstract link) (230) with multiple nodes of the UMG and is associated with a pair: <E0, M0> wherein E0 is the entity under consideration and M0 is the associated model. The corresponding multiple nodes (235) of the UMG that are connected by a dotted link are the entity instances (nodes) and are also associated with a pair: <E00, M00> wherein E00 is an instance of E0 and M00 is an entity-specific instantiated model derived from M0. Further, the entity instance node is also associated with a node score called as base score as depicted. As part of the UMG, entity instances are connected by a directed link to indicate the influence factors. For example, the entity instance E00 and the entity instance E12 are connected by a pair of directed links (245): the link from E00 to E12 is with an influence factor of 0.8 and the link from E12 to E00 is with an influence factor of 0.15. However, note that not all the links need to be in pairs: observe this in the link between E25 and E23 wherein only the entity instance E25 influences E23. Also, observe a negative influence between E25 and E21 (255).

FIG. 2b provides a brief description of the illustrative UMG. The elaboration (275) includes providing of the various key aspects of the UMG and an illustrative description of the entities. For example, the following entities are involved: DEPARTMENT, CS DEPARTMENT, FACULTY MEMBER, and STUDENT.

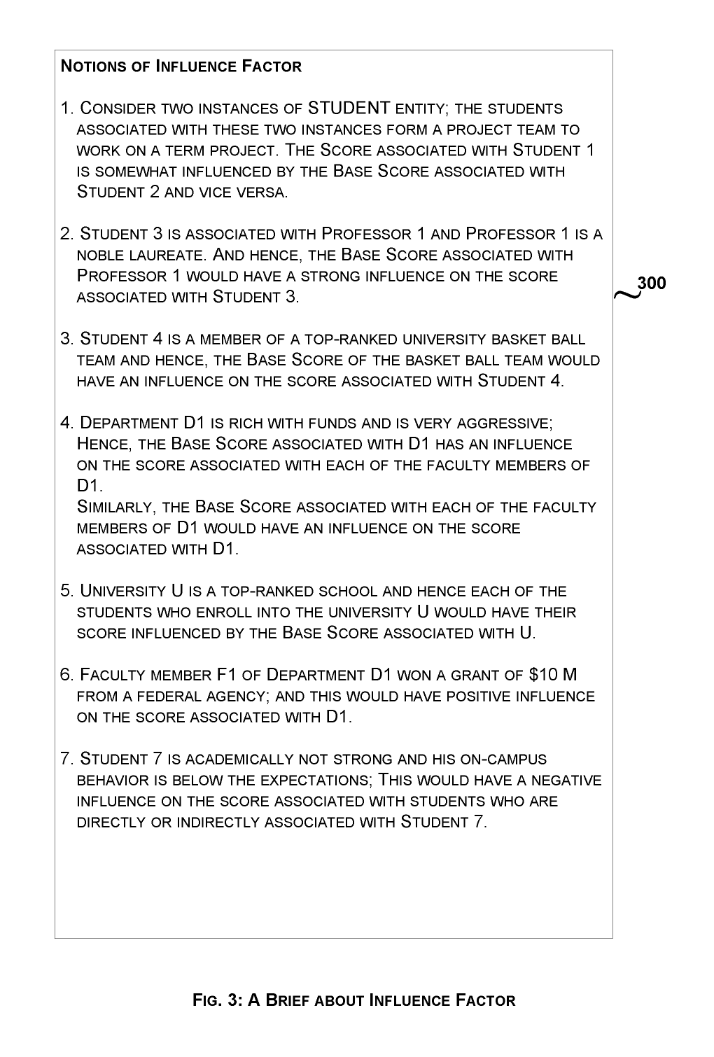

FIG. 3 depicts some of the aspects of Influence Factor.

### Notions of Influence Factor (300)

1. Consider two instances of STUDENT entity; the students associated with these two instances form a project team to work on a term project. The Score associated with Student 1 is somewhat influenced by the Base Score associated with Student 2 and vice versa.
2. Student 3 is associated with Professor 1 and Professor 1 is a noble laureate. And hence, the Base Score associated with Professor 1 would have a strong influence on the score associated with Student 3.
3. Student 4 is a member of a top-ranked university basket ball team and hence, the Base Score of the basket ball team would have an influence on the score associated with Student 4.
4. Department D1 is rich with funds and is very aggressive; Hence, the Base Score associated with D1 has an influence on the score associated with each of the faculty members of D1. Similarly, the Base Score associated with each of the faculty members of D1 would have an influence on the score associated with D1.
5. University U is a top-ranked school and hence each of the students who enroll into the university U would have their score influenced by the Base Score associated with U.
6. Faculty member F1 of Department D1 won a grant of $10 M from a federal agency; and this would have positive influence on the score associated with D1.
7. Student 7 is academically not strong and his on-campus behavior is below the expectations; This would have a negative influence on the score associated with students who are directly or indirectly associated with Student 7.

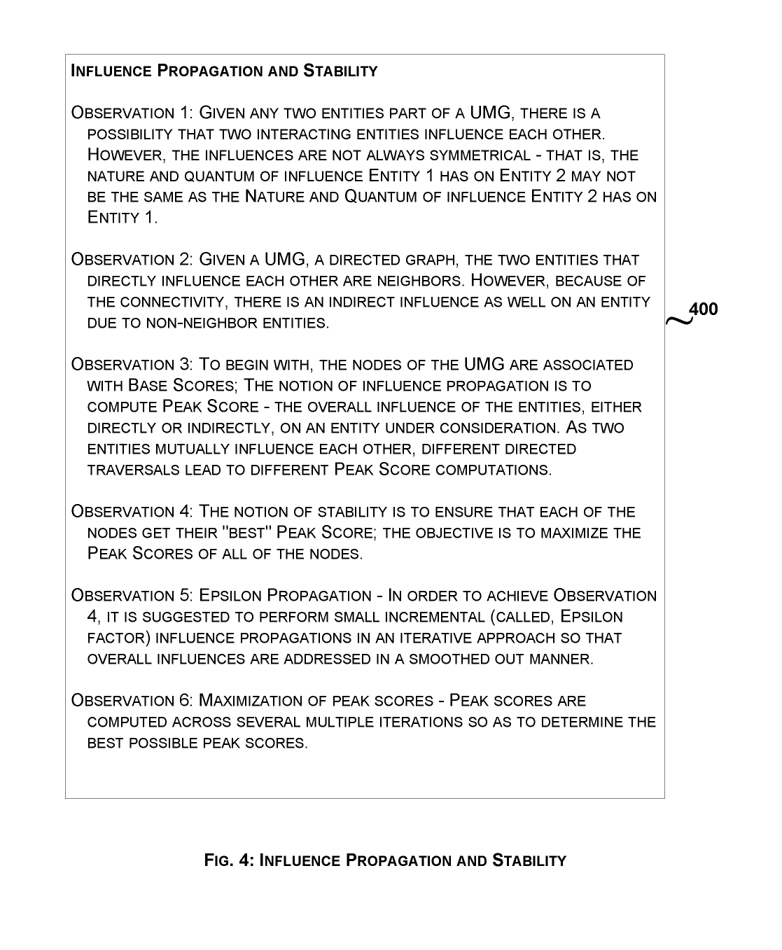

FIG. 4 depicts the notions of Influence Propagation and Stability.

Influence Propagation and Stability (400)
Observation 1: Given any two entities part of a UMG, there is a possibility that two interacting entities influence each other. However, the influences are not always symmetrical—that is, the nature and quantum of influence Entity 1 has on Entity 2 may not be the same as the Nature and Quantum of influence Entity 2 has on Entity 1.
Observation 2: Given a UMG, a directed graph, the two entities that directly influence each other are neighbors. However, because of the connectivity, there is an indirect influence as well on an entity due to non-neighbor entities.
Observation 3: To begin with, the nodes of the UMG are associated with Base Scores; The notion of influence propagation is to compute Peak Score—the overall influence of the entities, either directly or indirectly, on an entity under consideration. As two entities mutually influence each other, different directed traversals lead to different Peak Score computations.
Observation 4: The notion of stability is to ensure that each of the nodes get their “best” Peak Score; the objective is to maximize the Peak Scores of all of the nodes.
Observation 5: Epsilon Propagation—In order to achieve Observation 4, it is suggested to perform small incremental (called, Epsilon factor) influence propagations in an iterative approach so that overall influences are addressed in a smoothed out manner.
Observation 6: Maximization of peak scores—Peak scores are computed across several multiple iterations so as to determine the best possible peak scores.

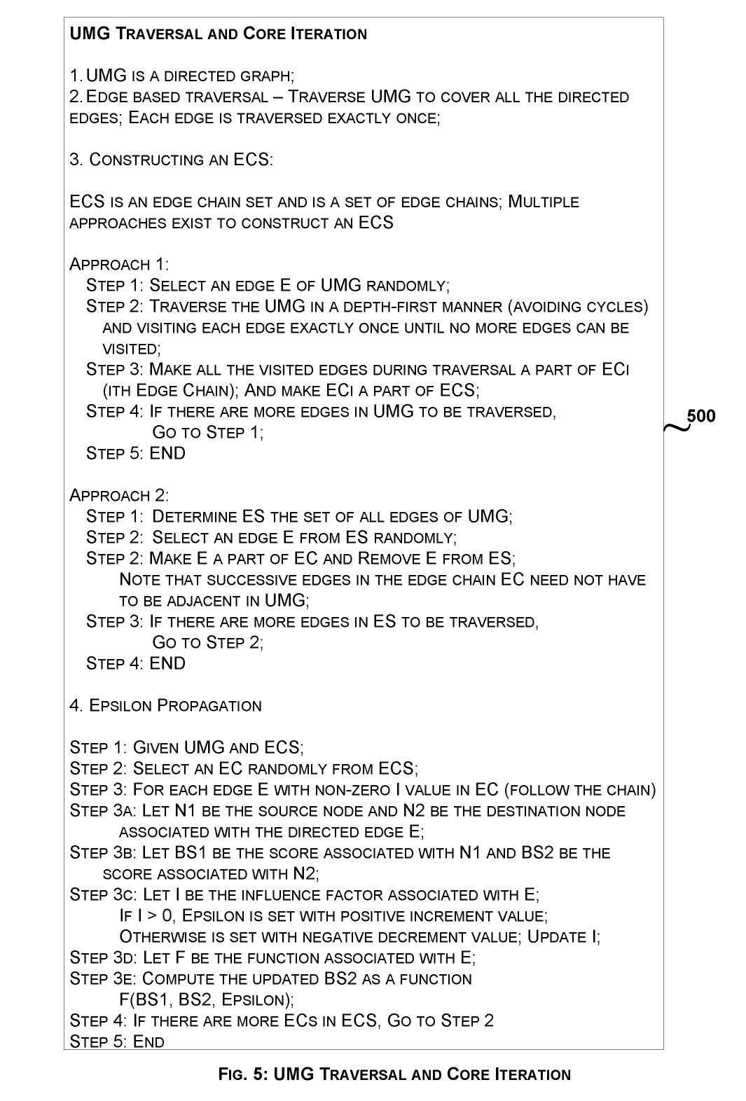

FIG. 5 depicts the steps involved in the UMG traversal and core iteration.

### UMG Traversal and Core Iteration (500)

1. UMG is a directed graph;
2. Edge based traversal—Traverse UMG to cover all the directed edges; Each edge is traversed exactly once;
3. Constructing an ECS:
   ECS is an edge chain set and is a set of edge chains; Multiple approaches exist for designing means to construct an ECS.

Approach 1:
Step 1: Select an edge E of UMG randomly;
Step 2: Traverse the UMG in a depth-first manner (avoiding cycles) and visiting each edge exactly once until no more edges can be visited;
Step 3: Make all the visited edges during traversal a part of ECi (ith Edge Chain); And make ECi a part of KS;
Step 4: If there are more edges in UMG to be traversed,
   Go to Step 1;
Step 5: END

Approach 2:
Step 1: Determine ES the set of all edges of UMG;
Step 2: Select an edge E from ES randomly;
Step 2: Make E a part of EC and Remove E from ES; Note that successive edges in the edge chain EC need not have to be adjacent in UMG;
Step 3: If there are more edges in ES to be traversed,
   Go to Step 2;
Step 4: END
4. Epsilon Propagation

Following steps can be carried out with the help of means for performing Epsilon Propagation:
Step 1: Given UMG and KS;
Step 2: Select an EC randomly from KS;
Step 3: For each edge E with non-zero I value in EC (follow the chain)
Step 3a: Let N1 be the source node and N2 be the destination node associated with the directed edge E;
Step 3b: Let BS1 be the score associated with N1 and BS2 be the score associated with N2;
Step 3c: Let I be the influence factor associated with E;
   If I>0, Epsilon is set with positive increment value;
   Otherwise is set with negative decrement value; Update I;
Step 3d: Let F be the function associated with E;
Step 3e: Compute the updated BS2 as a function F(BS1, BS2, Epsilon);
Step 4: If there are more ECs in ECS, Go to Step 2
Step 5: End

FIG. 5a provides additional steps related to UMG Traversal and Core Iteration.

UMG Traversal and Core Iteration (Contd.) (550)
5. Means for performing Core Iteration carry out the following steps:
   Step 1: Given UMG
   Step 2: Construct ECS
   Step 3: For each Edge Chain in ECS
   Step 3a: If there are no edges in Edge Chain with Absolute of I value>Epsilon,
      Go To Step 3;
   Step 3b: Perform Epsilon Propagation;
   Step 3c: Go To Step 3a;
   Step 4: END
6. Means for determining a Characteristic Value of ECS perform the following steps:
   Step 1: Given UMG and ECS
   Step 2: Perform Core Iteration based on UMG and KS;
   Step 3: Each node in UMG is associated with a score;
      To begin with, this score is called as Base Score;
      During the process of Incremental Influence propagation, the score associated is called as Present Score;
      On reaching stability, the score is called as Peak Score
   Step 4: Characteristic value is the sum of Present Score associated with each node of UMG.

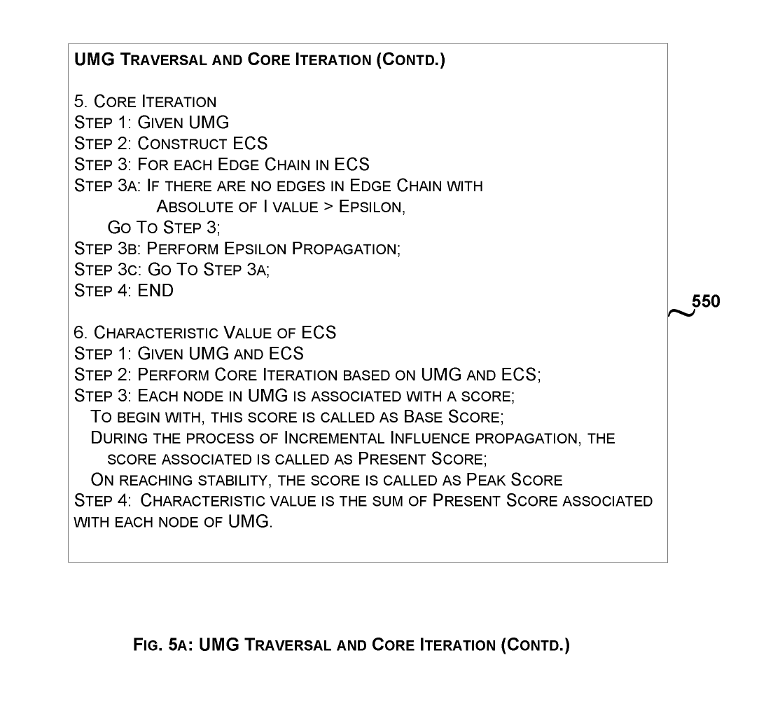

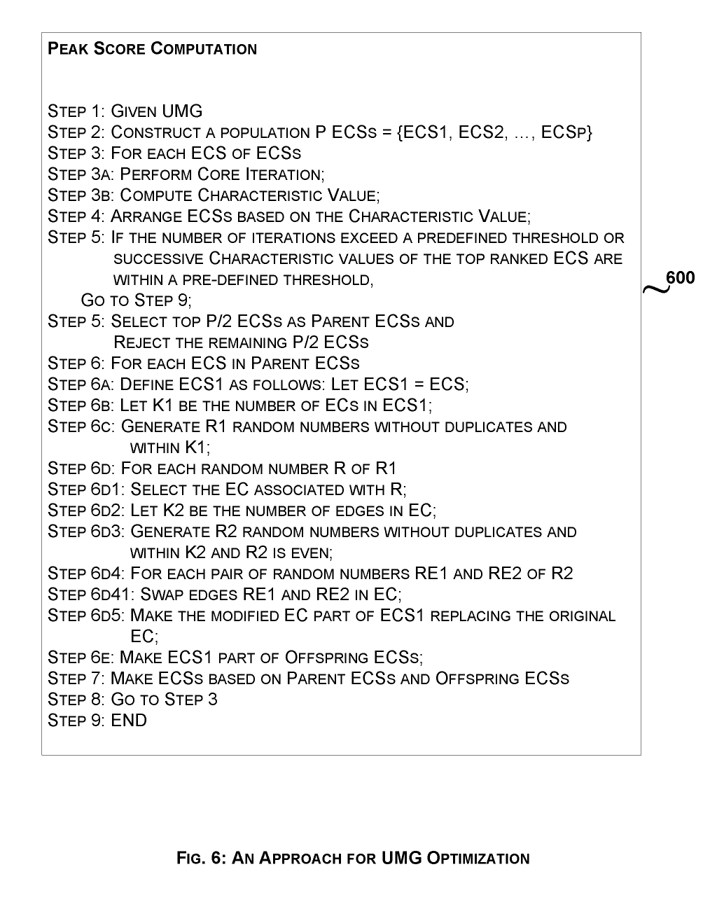

FIG. 6 provides an approach for UMG Optimization.

FIGS. 6, 6a, and 6b collectively provide means for determining a plurality of assessments based on peak scores.

Given a UMG, the objective is to determine the peak score associated with each of the nodes and this process is called as UMG optimization.

Peak Score Computation (600)
Step 1: Given UMG
Step 2: Construct a population P ECSs={ECS1, ECS2, . . . , ECSp}
Step 3: For each ECS of ECSs
Step 3a: Perform Core Iteration;
Step 3b: Compute Characteristic Value;
Step 4: Arrange ECSs based on the Characteristic Value;
Step 5: If the number of iterations exceed a predefined threshold or successive Characteristic values of the top ranked ECS are within a pre-defined threshold,
   Go to Step 9;
Step 5: Select top P/2 ECSs as Parent ECSs and
   Reject the remaining P/2 ECSs
Step 6: For each ECS in Parent ECSs
Step 6a: Define ECS1 as follows: Let ECS1=KS;
Step 6b: Let K1 be the number of ECs in ECS1;
Step 6c: Generate R1 random numbers without duplicates and within K1;
Step 6d: For each random number R of R1
Step 6d1: Select the EC associated with R;
Step 6d2: Let K2 be the number of edges in EC;
Step 6d3: Generate R2 random numbers without duplicates and within K2 and R2 is even;
Step 6d4: For each pair of random numbers RE1 and RE2 of R2
Step 6d41: Swap edges RE1 and RE2 in EC;
Step 6d5: Make the modified EC part of ECS1 replacing the original EC;
Step 6e: Make ECS1 part of Offspring ECSs;
Step 7: Make ECSs based on Parent ECSs and Offspring ECSs
Step 8: Go to Step 3
Step 9: END

FIG. 6a provides an assessment of an EI based on a UMG. The structural analysis of an EI (or a university) based on a UMG involves the following steps (630):
Step 1: Obtain an UMG associated with an EI;
Step 2: Compute Peak scores based on an optimized UMG;
Step 3: Based on the UMG associated with the computed peak scores, assess the various entities associated with the EI;
Step 4: END

FIG. 6b provides an approach for EI assessment. The assessment of EI at various levels is based on the computed peak scores that are associated with the various nodes of the university model graph. A high level description of the approach is provided below.

### Assessment of EI (650)

Step 1: Given—UMG with associated Peak Scores;
Step 2: Obtain an Entity E;
Step 3: To assess EI at E level:
Step 3a: Obtain all instantiated entities associated with E as IESet;
Step 3b: For each IE in IESet
Step 3b1: Obtain the associated peak score based on UMG;
Step 3c: Compute the assessment at E level based on the set of peak
   scores associated with IESet;
Step 4: Obtain an instantiated entity IE;
Step 5: To assess EI at IE level
Step 5a: Obtain the peak score P associated with IE based on UMG;
Step 5b: Obtain the entity E associated with IE;
Step 5c: Obtain all instantiated entities associated with E as IESet;
Step 5d: Obtain a set of peak scores, SP, associated with the
   instantiated entities of IESet based on UMG;
Step 5e: Assess at IE level based on P and SP;
Step 6: END

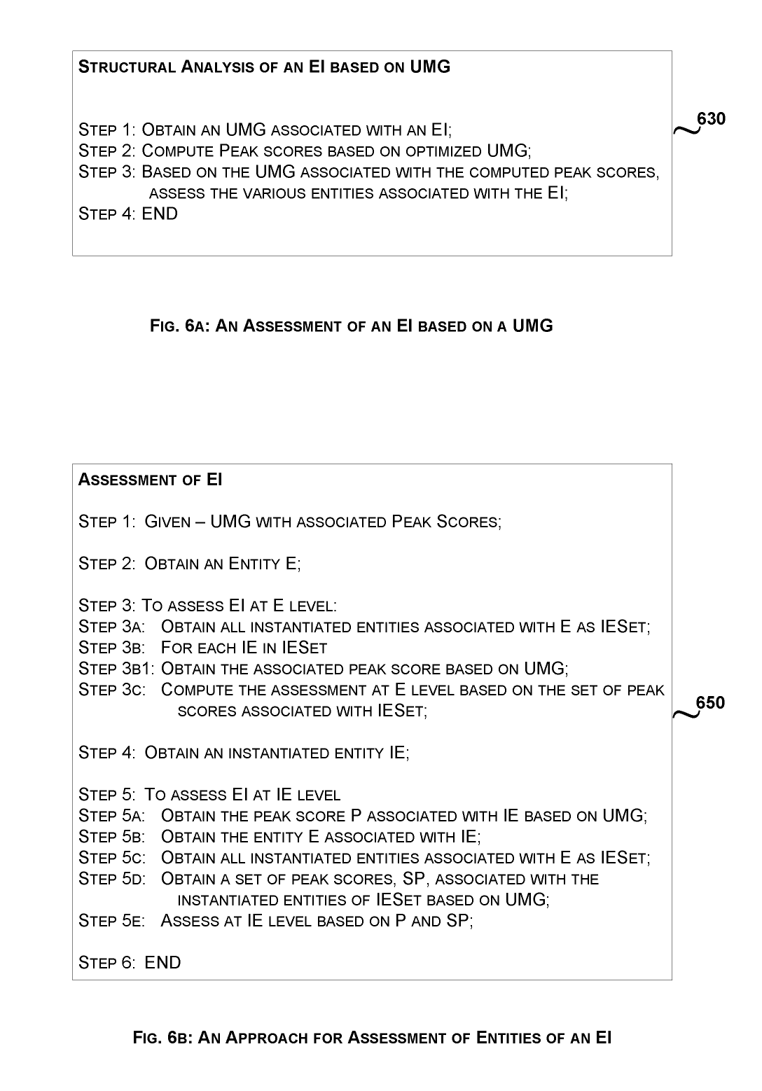

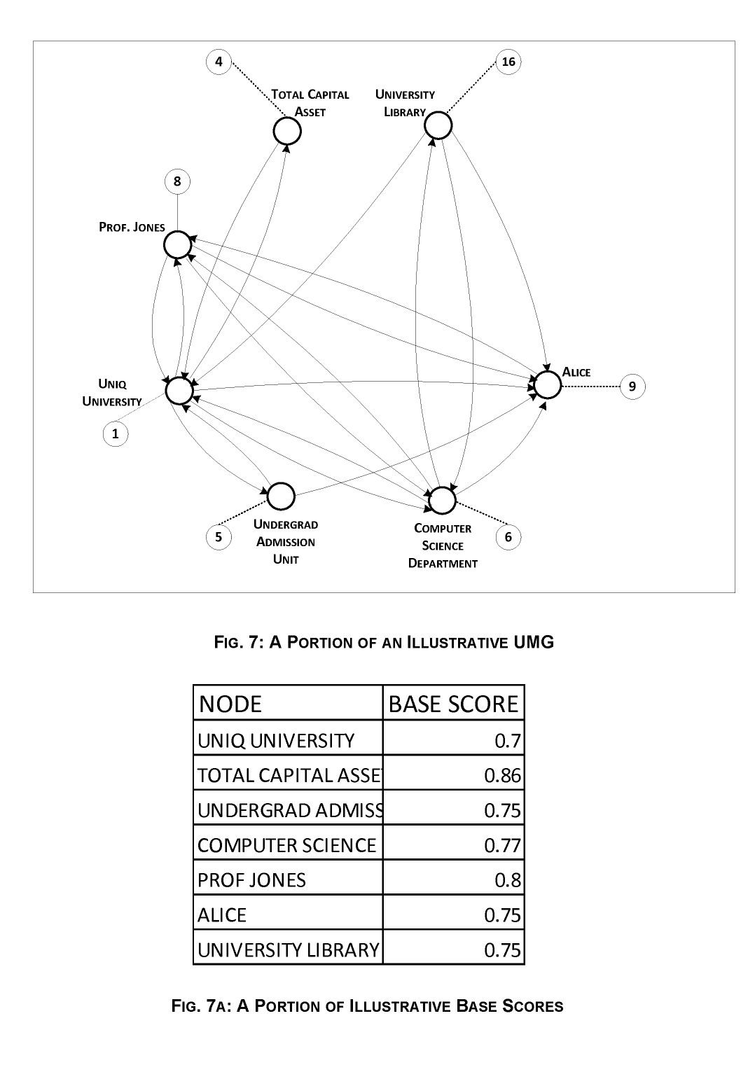

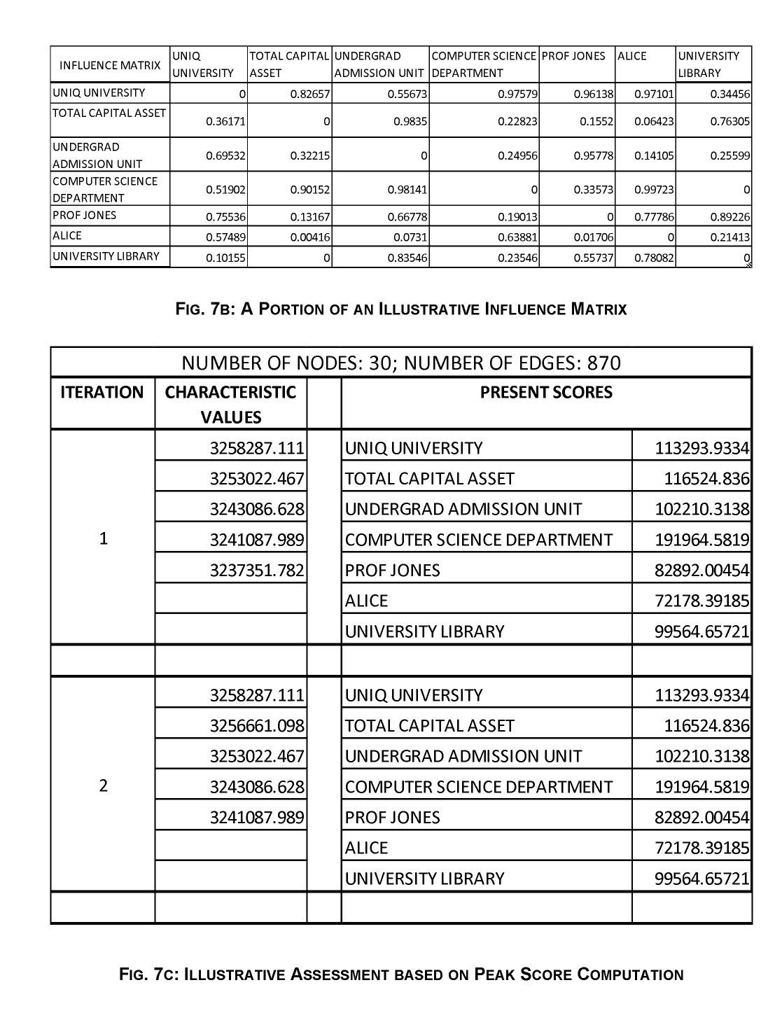

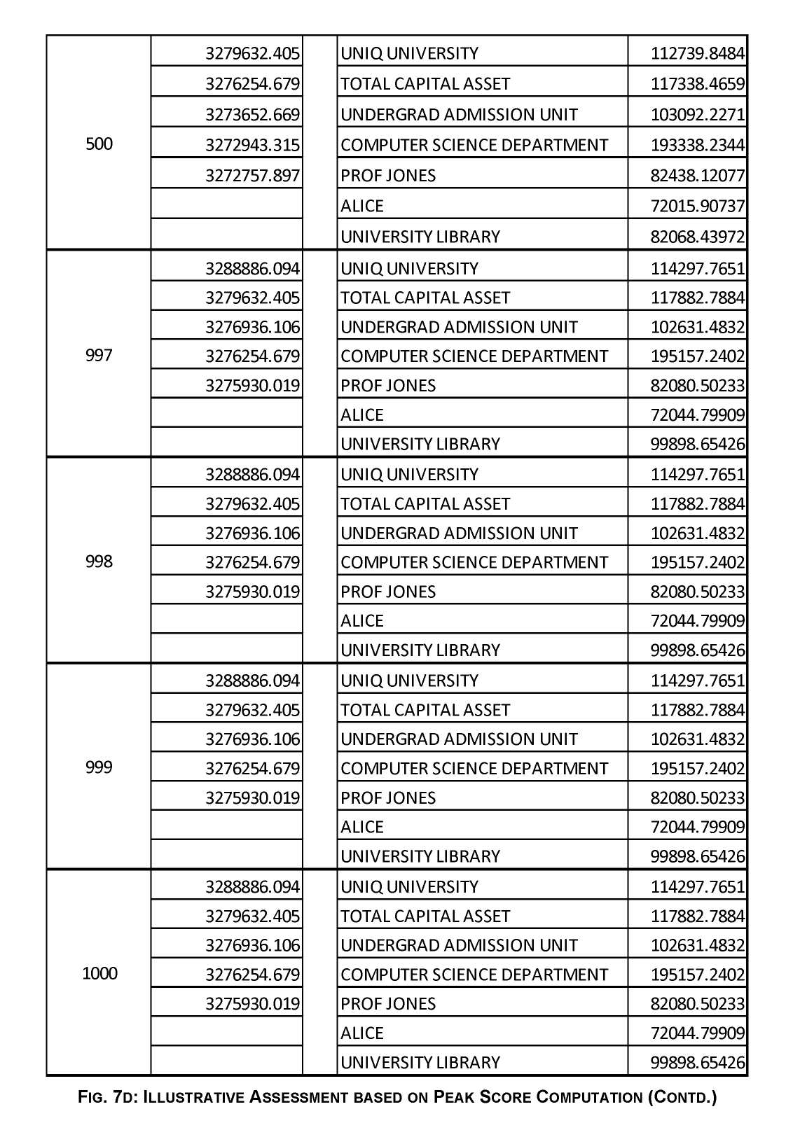

FIGS. 7, 7a, 7b, 7c, and 7d depict an illustrative assessment based on peak score computation. The first step in the assessment process of an educational institution is the construction of a UMG. A UMG is EI specific in the sense that the extent of detailing is based on the vastness of the EI and is also a design and operational decision. Two aspects are very important in a UMG: base scores and influence factors (I values). FIG. 7 depicts a portion of an illustrative UMG. Note that the nodes are connected using abstract edges to the abstract nodes and the numbers of the abstract nodes refer to the entities depicted in FIG. 1a.

Give such a UMG, FIG. 7a depicts a portion of the illustrative base scores associated with the nodes of the UMG. FIG. 7b provides a portion of the illustrative influence matrix.

And, finally, FIGS. 7c and 7d provide the intermediate and final results of the process of computation of peak scores of the nodes of the UMG. Note that the figures depict the iteration number, the characteristic values associated with top 5 edge chain sets, and the present scores associated with the select nodes of the top edge chain set. The iteration number 1000 depicts the computed peak scores of the select nodes of the UMG and note that the peak scores scaled by a factor of 1000000. These scores are used in the assessment of the EI associated with the UMG.

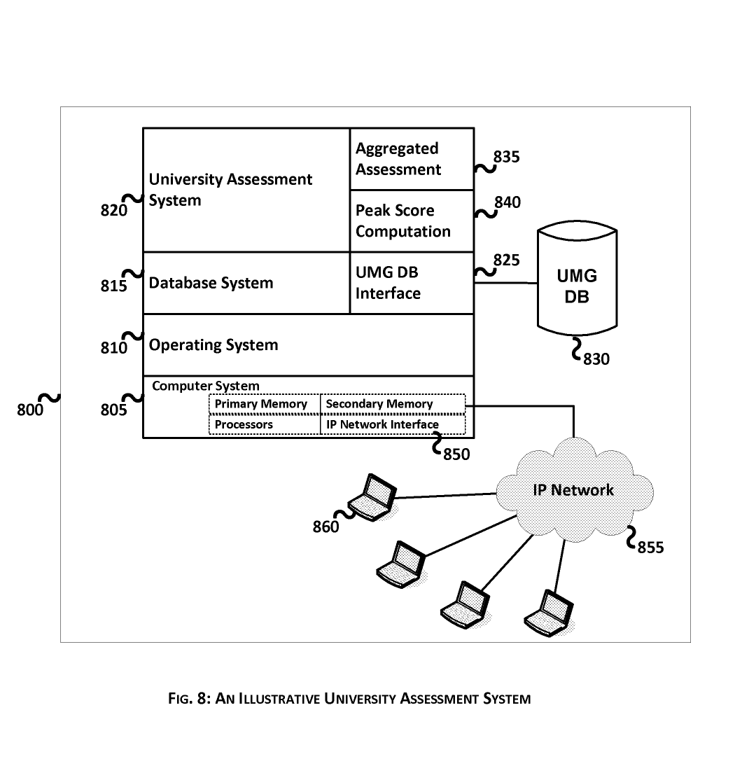

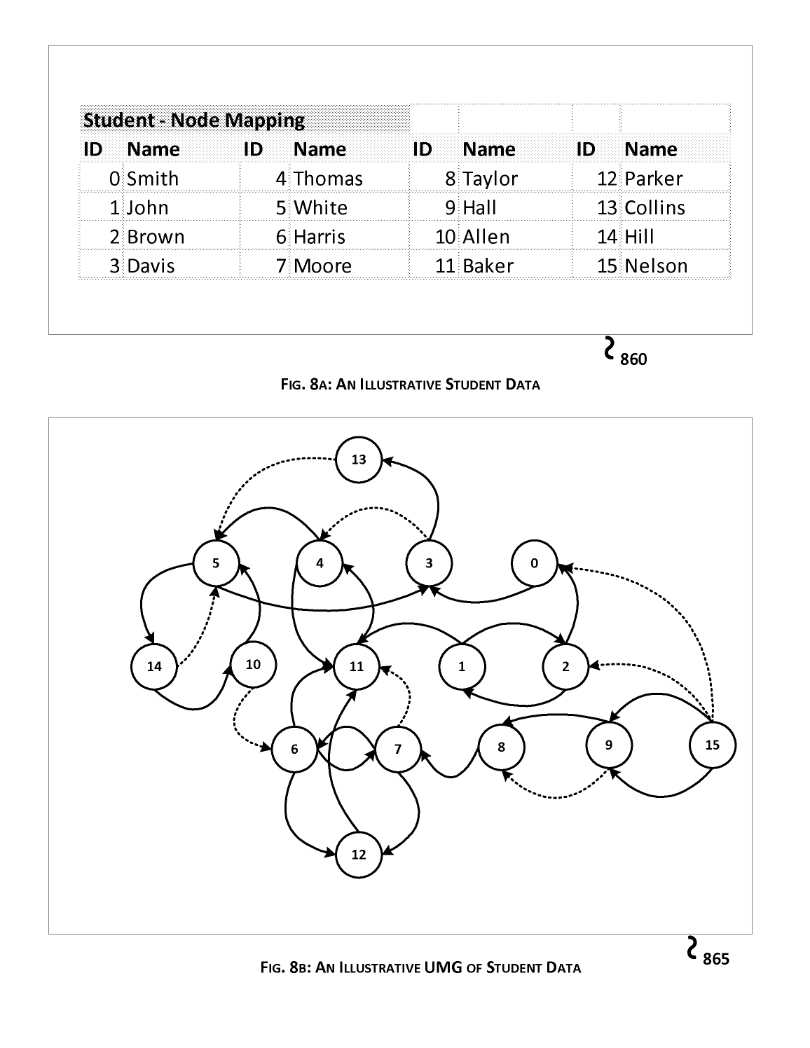

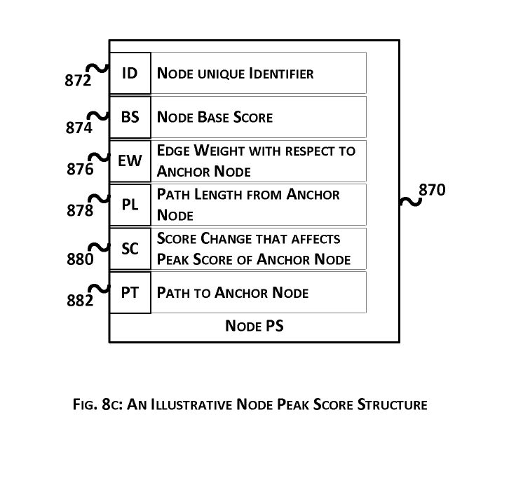

FIG. 8 provides an illustrative elaboration (800) of University Assessment System. In a preferred embodiment, the University Assessment System (820) is realized on a computer system (805) with several processors, primary memory units, secondary memory units, and network interfaces, and with an operating system (810) and a database system (815). The database system in particular comprises of a component UMG DB Interface (825) to help access UMG database (830). As depicted in the figure, the University Assessment System comprises of two key components, namely, Aggregated Assessment (835) and Peak Score Computation (840). The Peak Score Computation component is responsible for computing the effective score of, say, a student based on the UMG. Note that the UMG comprises of base scores associated with the students and their mutual influence values. And, the Aggregated Assessment component helps compute assessments at component level based on the peak scores computed at element level. The IP Network Interface (850) is used to connect the computer system to an Internet Protocol (IP) Network (855) so that several users (860) can connect and interact with the University Assessment System through the Internet or an intranet.

FIG. 8a depicts an illustrative student data. In particular, 860 provides the mapping of the node IDs of the UMG and the students. For example, node ID 1 corresponds to the student John.

FIG. 8b depicts an illustrative UMG data associated with the various students and explicitly brings out mutual influences (865). Note in particular that the student Smith (node ID 0) influences the student Davis (node ID 3) positively and gets influenced negatively by the student Nelson (node ID 15).

The invention mainly focuses on determining the impact of the influences of students and say, faculty members of a university, on the performance of the students of the university. In one of the embodiments, the performance is measured based on the scores a student obtained in tests, assignments, and examinations. This measured performance is the base scores associated with the students and is a normalized value between 0 and 1. The objective is to measure the effect of the university environment upon a student and in a particular embodiment, this effect is measured in terms of positive and negative influences of the other students and say, faculty members upon the student, and the positive and negative influences effected by this student upon the other students and say, faculty members. Again, the influence values are normalized and are a value between −1 and +1. In a particular embodiment, the influences are determined, say, using questionnaires.

FIG. 8c depicts an illustrative Node PS (peak score) structure (870). The Node PS structure that plays a role in determining the peak score of a node (also called as an anchor node) is associated with every node that affects the peak score of the anchor node. The main elements of the Node PS structure are:

(a) ID: Node unique identifier of a node (872)
(b) BS: Base Score associated with the node (874)
(c) EW: Edge weight with respect to the anchor node (876)
(d) PL: Path Length of a path from the anchor node to the node under consideration (878)
(e) SC: The quantum of Score Change that affects the peak score of the anchor node (880)
(f) PT: A path either from the anchor node to the node under consideration or from the node under consideration to the anchor node.

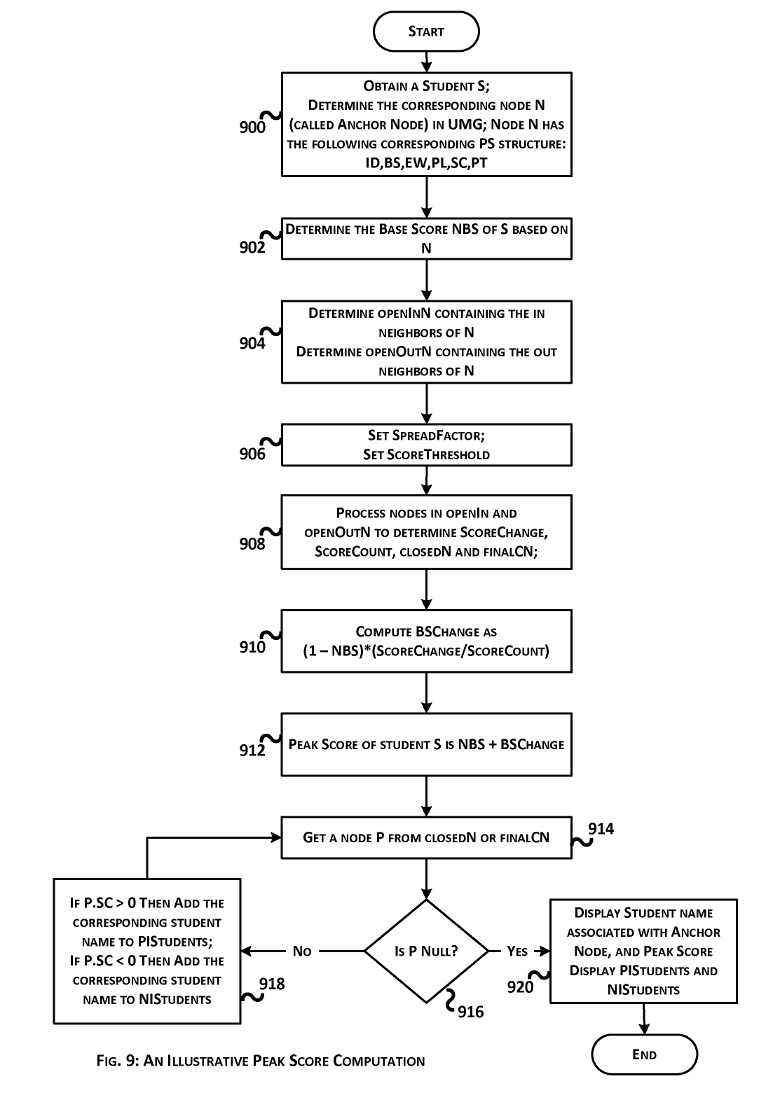

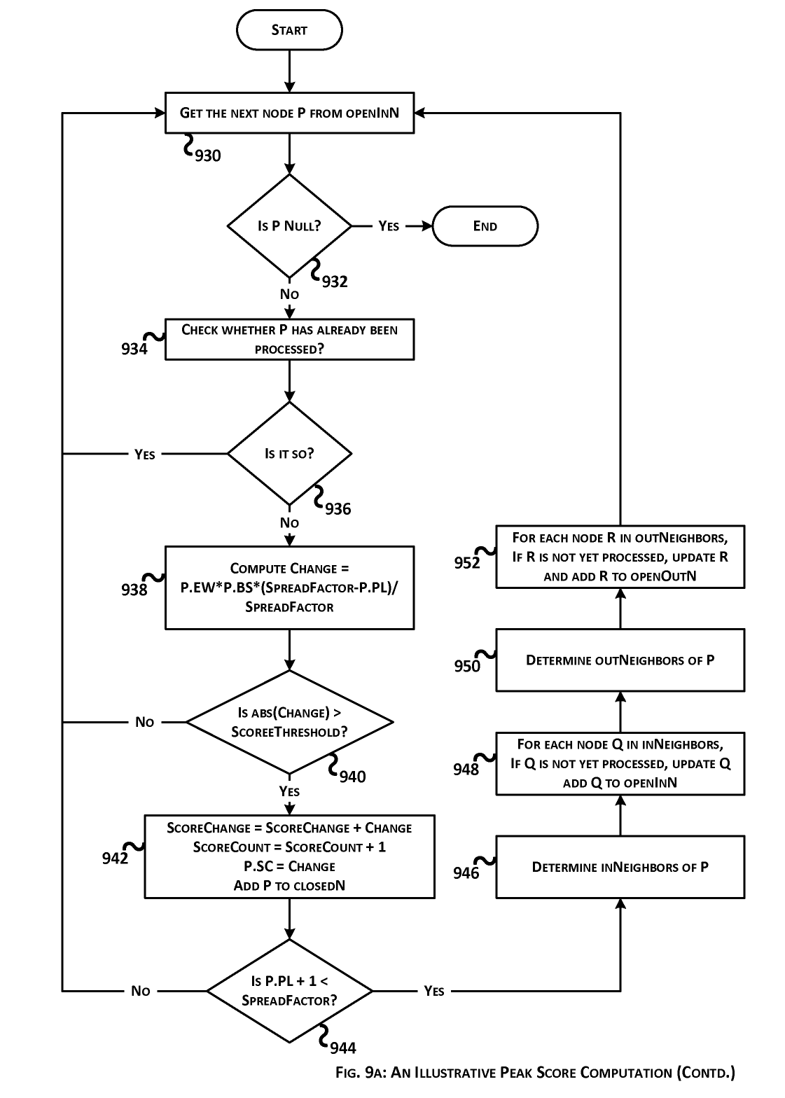

FIG. 9 depicts an approach for the computation of a peak score associated with a student of the university. Obtain the student S and determine the corresponding node N with respect to the UMG associated with the university (900). The node N is also called as an anchor node. The node N is also associated with a Node PS (peak score) structure comprising the fields ID, BS, EW, PL, SC, PT. Determine the Base Score NBS associated with N (902). In a preferred embodiment, the base score of a student corresponds with the performance measure associated with the student.

Determine openInN containing the in-neighbors of N (904); in other words, openInN contains those nodes from the UMG that have an edge directed to N.

Similarly, determine openOutN containing those nodes from the UMG that have an edge directed from N.

Set the controlling values for SpreadFactor and ScoreThreshold. The value assigned to SpreadFactor determines the allowable path length of the nodes that could affect the base score of the anchor node. Similarly, the value assigned to ScoreThreshold determines whether a particular node could practically affect the base score of the anchor node.

Process nodes in openInN and openOutN to determine the cumulative ScoreChange and ScoreCount (908). The ScoreChange indicates the quantum of change that affects the base score of the anchor node and ScoreCount indicates the number of nodes that contributed to this change. Also determine closedN (the nodes that directly affect the base score of the anchor node) and finalCN (that nodes that indirectly affect the base score of the anchor node).

Compute BSChange as (1−NBS)*(ScoreChange/ScoreCount) (910).

Compute Peak Score of student S as NBS+BSChange (912)

Get a node P from closedN or finalCN (914). If P is not null (916),

If the SC value associated with the node P exceeds 0 (based on the node PS structure associated P and P.SC), then add the corresponding student name to PIStudents (918). Note that PIStudents is a set of students that affects the student S positively.

Similarly, if the SC value associated with the node P is less than 0, then add the corresponding student name to NIStudents. Node that NIStudents is a set of students that affects the student S negatively.

If P is null (916), Display Student name associated with Anchor Node, and Peak Score (920); And Display the list of students who impact the student S both positively and negatively using PIStudents and NIStudents.

FIG. 9a provides additional information related to peak score computation. There are two steps involved in the processing to compute ScoreChange and ScoreCount. The first step is to iteratively process the nodes contained in openInN; and the second step is to iteratively process the nodes contained in openOutN. The second step is described in detail in FIG. 9b.

Get the next node P from openInN (930). The procedure is to estimate impact of each of the nodes in openInN on N and further determine if any more nodes could also impact N by virtue of the nodes in openInN.

If P is null (932), then everything that could practically impact N has been determined; end.

Otherwise (932), check whether P has already been processed (934).

If so (936), go to process the remaining nodes in openInN.

If it not so (936), Compute Change=P.EW*P.BS*(SpreadFactor-P.PL)/SpreadFactor. Note, for example, P.EW denotes the EW value of the Node Peak structure of P.

Check whether absolute value of Change is >ScoreThreshold (940).

If so, ScoreChange=ScoreChange+Change; ScoreCount=ScoreCount+1; P.SC=Change; and

Add P to closedN (942).

Check whether P.PL+1<SpreadFactor (944). If so, determine in Neighbors of P (946). The set in Neighbors of P consists of the nodes of the UMG that have an edge directed to P.

For each node Q in in Neighbors, If Q is not yet processed, update Q; Add Q to openInN (948). Note that the path length of each Q is one more than the path length of P. And also, Q.PT is updated appropriately to reflect the path from the node Q to node N.

Similarly, determine the outNeighbors of P (950). The set outNeighbors of consists of the nodes of the UMG that have an edge directed from P.

For each node R in outNeighbors, If R is not yet processed, update R and add R to openOutN (952). Again note that the path length of each R is one more that the path length of P. Also, R.PT is updated appropriately to reflect the path from the node N to node R.

FIG. 9b provides additional information related to peak score computation and elaborates the processing of the nodes in openOutN.

Get the next node P from openOutN (960). The procedure is to identify a sequence of nodes leading back to the node N and use the base score associated with N to compute the impact.

Check whether P is null (962). If so, the overall impact computation is completed; end.

Otherwise, check whether P has already been processed (964).

If so (966), go to process the next node in openOutN.

Otherwise, Determine P1 from closedN that matches with P (968). The objective is to check whether a sequence of nodes in openOutN terminated with P1 can be looped back to N.

If P1 is not null (970) (that is a match is found), Add P to finalCN and Compute pl=P.PL+P1.PL (972).

Note that this path computation takes into account the sequence length and also loop back length.

If pl<SpreadFactor (974),

Compute Change=((P.EW*/(P.PL+1))*NBS*(SpreadFactor-pl)/SpreadFactor (976).

Note that the edge weight associated with the node P (that is, P.EW) is the accumulated edge weight based on the node sequence, and the impact computation is based on the base score associated with the node N (that is, NBS).

Otherwise (974), go to process the next node in openOutN.

If absolute value of Change exceeds ScoreThreshold (978), then compute ScoreChange=ScoreChange+Change and ScoreCount=ScoreCount+1; update P with P.SC=ScoreChange (980); go to process the next node in openOutN.

If P is null (970), Determine outNeighbors of P (982).

For each node Q in outNeighbors,

If Q is not yet processed, update Q, and add Q to openOutN (984).

The edge weight associated with Q.EW is updated based on the sum of P.EW and Q.EW.

Note that the path length of each Q is one more that the path length of P.

Also, Q.PT is updated appropriately to reflect the path from the node N to node Q. Go to process the next node from openOutN.

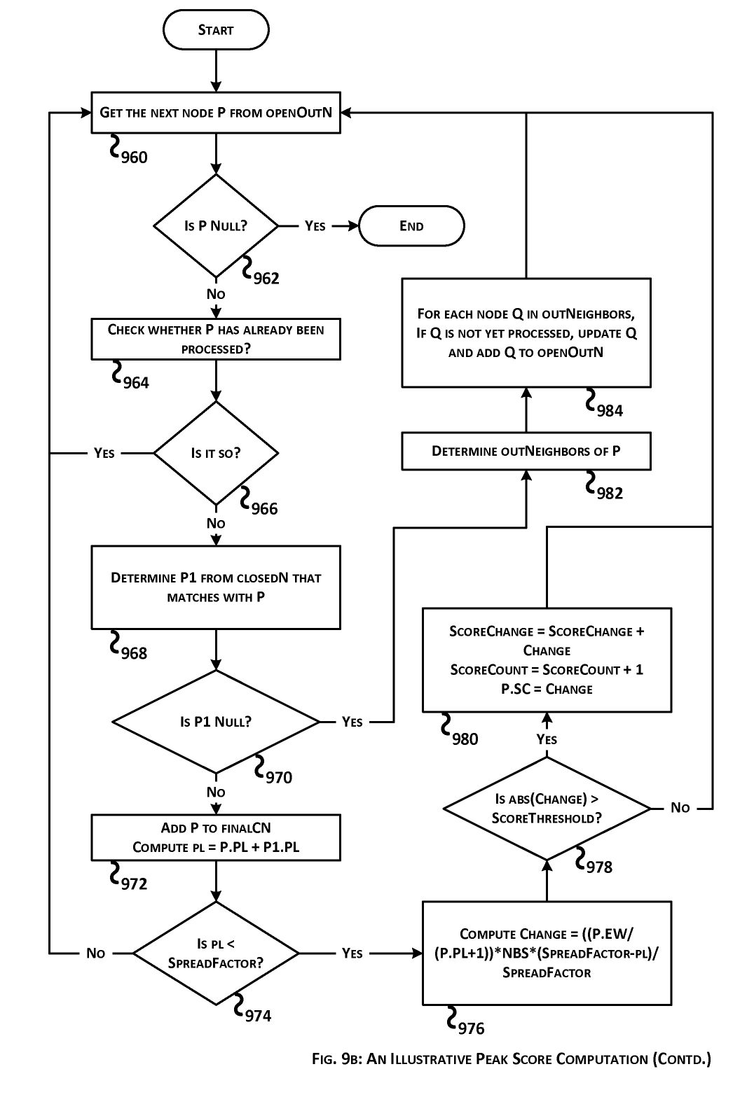

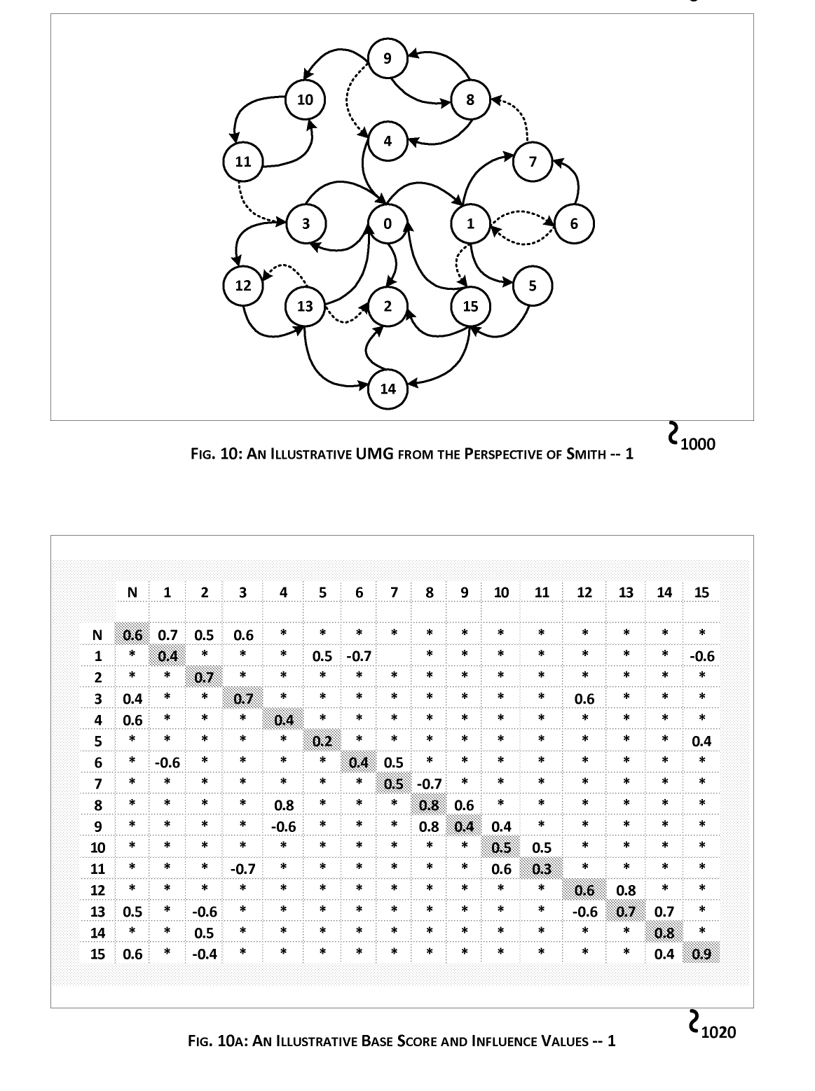

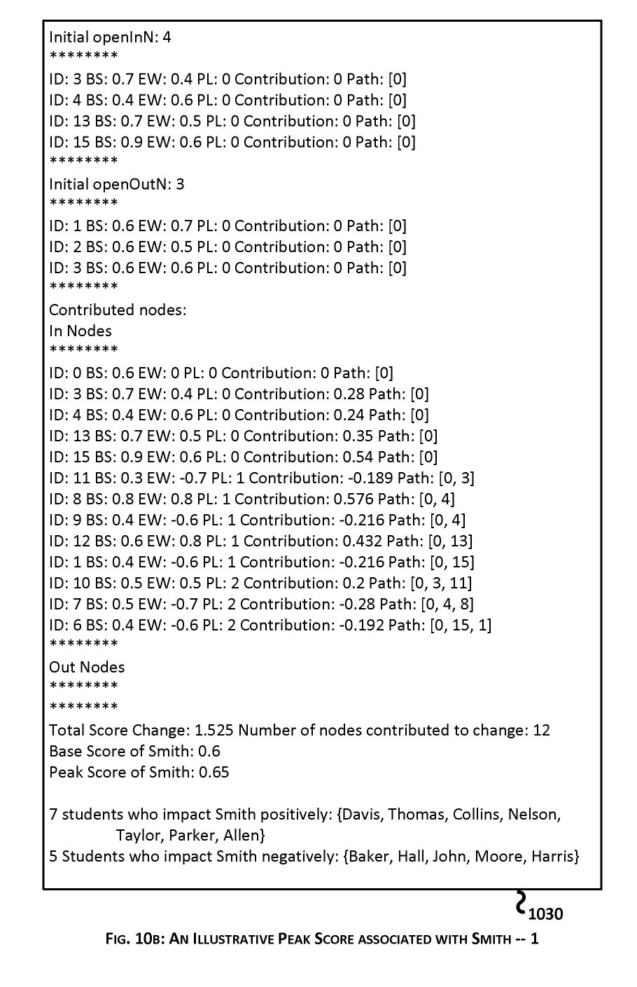

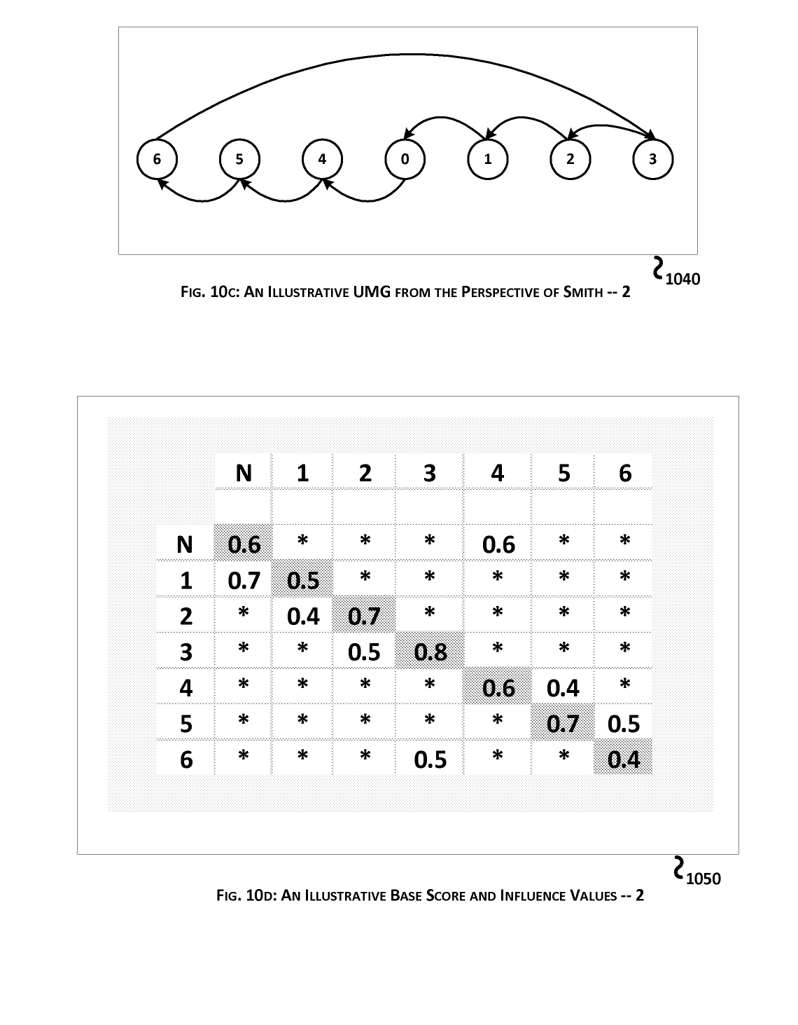

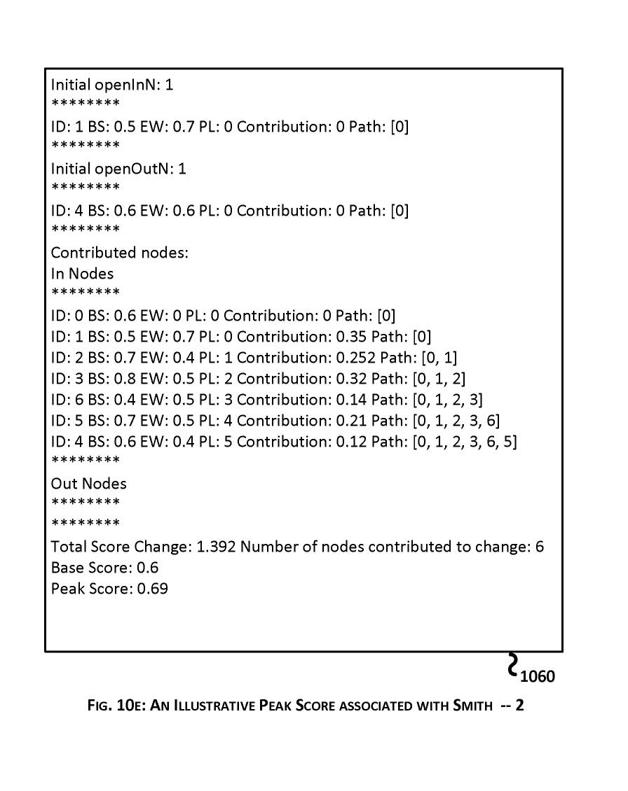

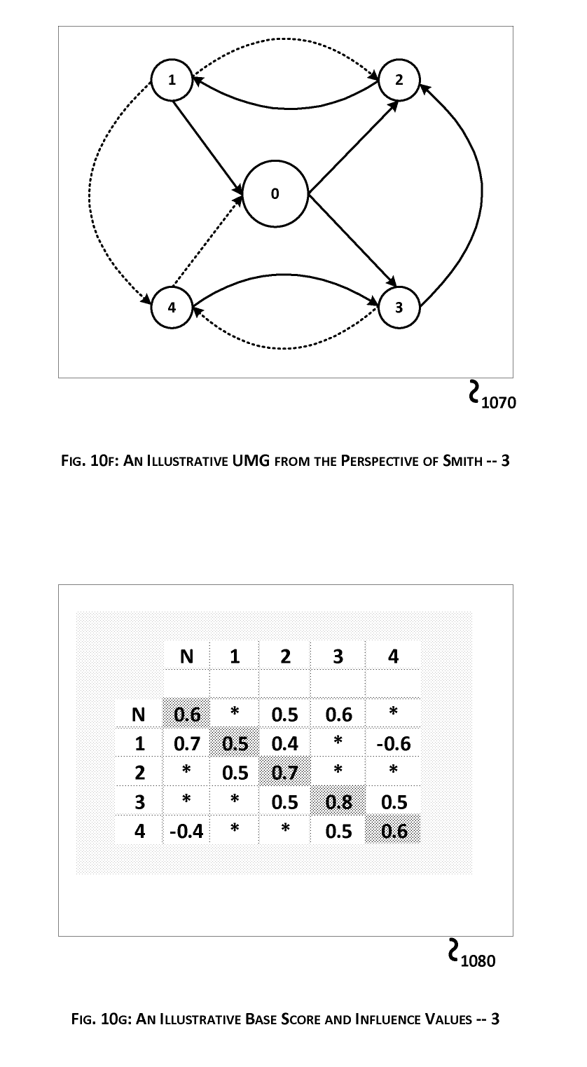

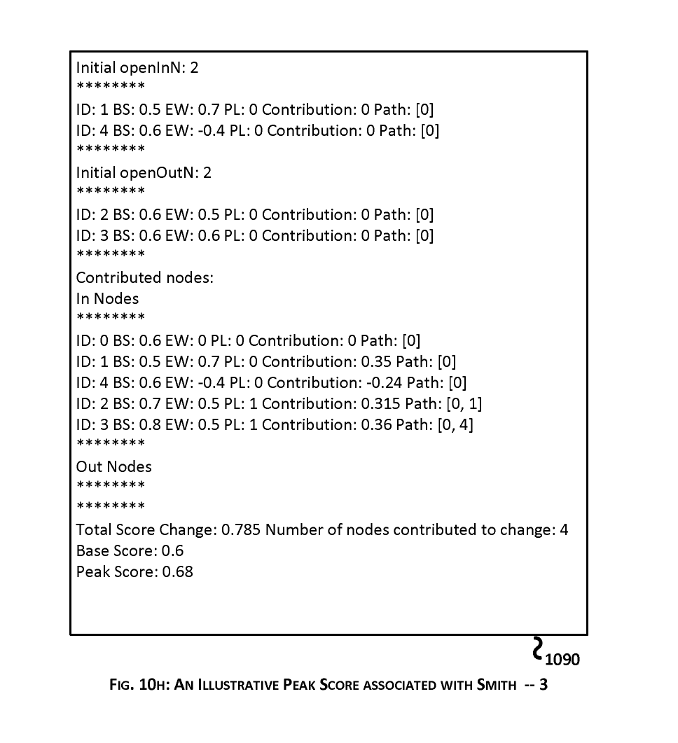

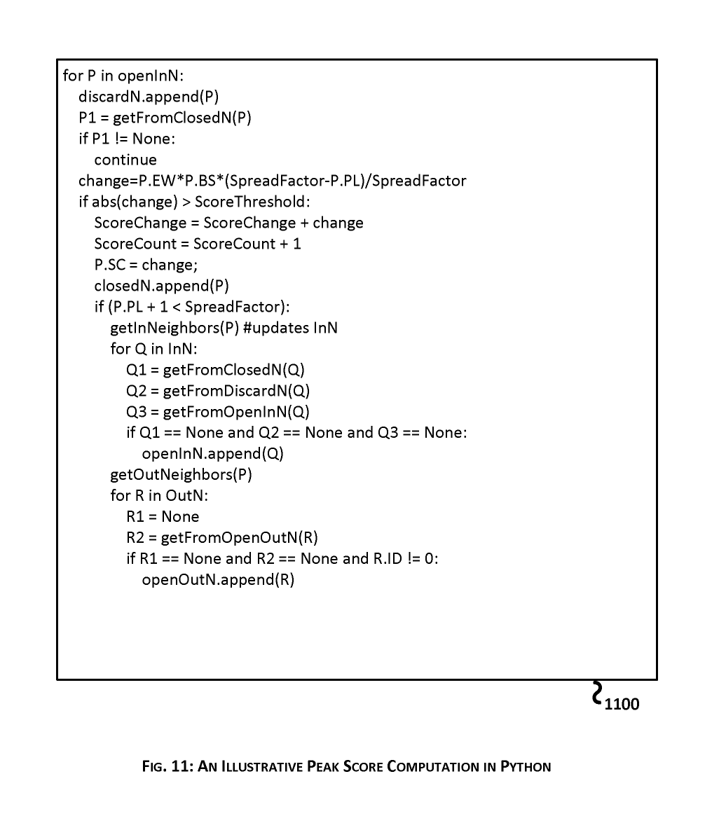

FIG. 10 provides an illustrative UMG from the perspective of the student Smith. Note that the influence values are depicted as directed edge weights with dotted edge indicating a negative influence (1000). Also, the student names associated with the nodes of the UMG are based on the mapping depicted FIG. 8a.

FIG. 10a depicts an illustrative base scores and influence values related to the UMG depicted in FIG. 10. Observe that the matrix (1020) incorporates both base scores and influence values. Base scores are provided as the diagonal elements while the non-diagonal elements provide the influence values. In particular N, 1, 2, . . . , 15 represent the nodes of the UMG and correspond to the 16 students depicted in FIG. 8a. Note that node ID N and node ID 0 are used interchangeably and both correspond to the student Smith. As an illustration, the base score associated with node with ID 6 is 0.4, a directed edge from node with ID 6 to node with ID 1 with an edge weight of −0.6 (negative influence value), a directed edge from node with ID 6 to node with ID 7 with an edge weight of 0.5 (positive influence value), and a directed edge from node with ID 1 to node with ID 6 with an edge weight of −0.7.

FIG. 10b provides an illustrative peak computation associated with the student Smith. Observe that 1030 provides the initial values of openInN, openOutN, the nodes that contribute to the peak score of node 0, the path in the UMG from node 0 to each of the contributed nodes. Finally, the total score change along with the count of nodes contributed to the change, and the computed peak score of Smith are also displayed. Also, observe that 7 students positively affected Smith (Davis, Thomas, Collins, Nelson, Taylor, Parker, and Allen) and five students negatively (Baker, Hall, John, Moore, and Harris).

FIG. 10c provides another illustrative UMG from the perspective of the student Smith (1040).

FIG. 10d provides the illustrative base score and influence values (1050) associated with the UMG depicted in FIG. 10c.

FIG. 10e depicts the peak score computation results (1060).

FIG. 10f provides yet another illustrative UMG from the perspective of the student Smith (1070).

FIG. 10g provides the illustrative base score and influence values (1080) associated with the UMG depicted in FIG. 10f.

FIG. 10h depicts the peak score computation results (1090).

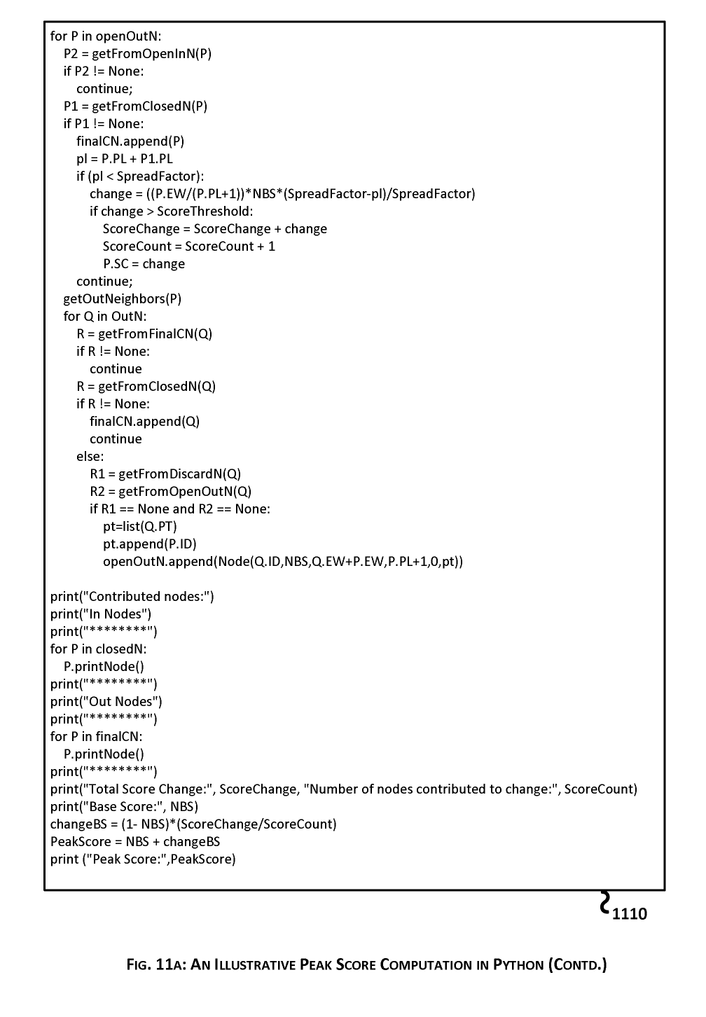

FIG. 11 depicts an illustrative peak score computation module in Python programming language. In particular, 1100 illustrates the processing of the nodes in openInN as per the flowchart depicted in FIG. 9a.

FIG. 11a provides another illustrative peak score computation module in Python programming language. In particular, 1110 illustrates the processing of the nodes in openOutN as per the flowchart depicted in FIG. 9b.

Thus, a system and method for influence based structural analysis of a university is disclosed. Although the present invention has been described particularly with reference to the figures, it will be apparent to one of the ordinary skill in the art that the present invention may appear in any number of systems that perform influence based structural analysis. It is further contemplated that many changes and modifications may be made by one of ordinary skill in the art without departing from the spirit and scope of the present invention.

We claim:

1. A computer-implemented method to compute a peak score of a student S of a plurality of students of a university, a plurality of positively influencing students of said student S, and a plurality of negatively influencing students of said student S using
a plurality of base scores associated with said plurality of students of said university,
a plurality of positive influence values comprising a positive influence value associated with each of said plurality of students with respect to each of said plurality of students,
a plurality of negative influence values comprising a negative influence value associated with each of said plurality of students with respect to each of said plurality of students,
a graph with a plurality of nodes, a plurality of directed edges, and a plurality of edge weights that collectively represents said plurality of base scores, said plurality of positive influence values, and a plurality of negative influence values,
a plurality of peak score structures associated with said plurality of nodes, wherein a peak score structure of said plurality of peak score structures comprises of an ID (identifier), a BS (base score),
an EW (edge weight), a PL (path length), an SC (score change), and a PT, and
a plurality of mappings, wherein each of said plurality of mappings maps a student of said plurality of students with a node of said plurality of nodes,
said method performed on a computer system comprising at least one processor, one or more memory units, and one or more network interfaces for connecting said computer system to an Internet Protocol (IP) network, said method comprising the steps of:
determining, with at least one processor, a student S base score of said student S based on said plurality of base scores;
determining, with at least one processor, a node N of said plurality of nodes, wherein said node N is associated with said student S;
determining, with at least one processor, a plurality of open-in-nodes, wherein each node of said plurality of open-in-nodes is a part of said plurality of nodes and a node of said plurality of open-in-nodes has a directed edge of said plurality of directed edges to said node N;
determining, with at least one processor, a plurality of open-out-nodes, wherein each node of said plurality of open-out-nodes is a part of said plurality of nodes and a node of said plurality of open-out-nodes has a directed edge of said plurality of directed edges from said node N;
determining, with at least one processor, a spread factor, wherein said spread factor is a pre-defined threshold;
determining, with at least one processor, a score threshold, wherein said score threshold is a pre-defined threshold;
computing, with at least one processor, a total score change, a score count, a plurality of closed nodes, a plurality of final closed nodes based on said plurality of open-in-nodes and said plurality of open-out-nodes;
computing, with at least one processor, a base score change based on said student S base score, said total score change, and said score count;
computing, with at least one processor, said peak score based on said student S base score and said base score change;
determining, with at least one processor, said plurality of positively influencing students based on said plurality of closed nodes, said plurality of final closed nodes, and said plurality of mappings, wherein each of said plurality of positively influencing students influences said student S positively; and
determining, with at least one processor, said plurality of negatively influencing students based on said plurality of closed nodes, said plurality of final closed nodes, and said plurality of mapping, wherein each of said plurality of negatively influencing students influences said student S negatively.

2. The method of claim 1, wherein said step for computing said total score change, said score count, said plurality of closed nodes, and said plurality of final closed nodes, further comprising the steps of:
determining a node P from said plurality of open-in-nodes, wherein said node P is not null and said node P has not yet been processed;
determining a node P peak score structure of said plurality of peak score structures, wherein said node P peak score structure is associated with said node P;
determining a node P identifier based on an ID of said node P peak score structure;
determining a node P edge weight based on an EW of said node P peak score structure;
determining a node P base score based on a BS of said node P peak score structure;
determining a node P path length based on a PL of said node P peak score structure;
determining a node P score change based on a SC of said node P peak score structure;
determining a node P path based on a PT of said node P peak score structure;
computing a change based on (said node P edge weight*said node P base score* (said spread factor−said node P path length)/said spread factor), wherein the absolute value of said change exceeds said score threshold;
computing said total score change as the sum of said total score change and said change;
computing said score count as the sum of said score count and unity;
setting said SC of said node P peak structure based on said change;
adding said node P to said plurality of closed nodes;
determining a plurality of in-neighbors of said node P, wherein (said node P path length+1) is less than said spread factor, a node of said plurality of in-neighbors is a part of said plurality of nodes, and said node has a directed edge of said plurality of edges to said node P;
adding a node Q of said plurality of in-neighbors to said plurality of open-in-nodes, wherein said node Q has not yet been processed, a PL of a node Q peak structure of said plurality of node peak structures associated with said node Q is one more than said node P path length, and a PT of said node Q peak structure includes said node P path and said node P identifier;
determining a plurality of out-neighbors of said node P, wherein (said node P path length+1) is less than said spread factor, a node of said plurality of out-neighbors is a part of said plurality of nodes, and said node has a directed edge of said plurality of edges from said node P; and
adding a node R of said plurality of out-neighbors to said plurality of open-out-nodes, wherein said node R has not yet been processed, a PL of a node R peak structure of said plurality of node peak structures associated with said node R is one more than said node P path length, and a PT of said node R peak structure includes said node P path and said node P identifier.

3. The method of claim 2, wherein said method further comprising the steps of:
determining a node P from said plurality of open-out-nodes, wherein said node P is not null and said node P has not yet been processed;
determining a node P peak score structure of said plurality of peak score structures, wherein said node P peak score structure is associated with said node P;
determining a node P identifier based on an ID of said node P peak score structure;
determining a node P edge weight based on an EW of said node P peak score structure;
determining a node P base score based on a BS of said node P peak score structure;
determining a node P path length based on a PL of said node P peak score structure;
determining a node P score change based on a SC of said node P peak score structure;
determining a node P path based on a PT of said node P peak score structure;
determining a node P1 of said plurality of closed nodes, wherein an ID of a node P1 peak score structure of said plurality of node peak structures associated with said node P1 matches with said node P identifier;
adding said node P to said plurality of final closed nodes;
determining a node P1 path length based on a PL of said node P1 peak structure;
computing a path length based on (said node P path length+node P1 path length), wherein said path length is less than said spread factor;
computing a change based on ((said node P edge weight/(node P path length+1))*said student S base score*(said spread factor−said path length)/said spread factor), wherein the absolute value of said change exceeds said score threshold;
computing said total score change as the sum of said total score change and said change;
computing said score count as the sum of said score count and unity; and
setting said SC of said node P peak structure based on said change.

4. The method of claim 3, wherein said method further comprising the steps of:
determining a node P from said plurality of open-out-nodes, wherein said node P does not match with any node in said plurality of closed nodes;
determining a plurality of out-neighbors of said node P, wherein a node of said plurality of out-neighbors is a part of said plurality of nodes, and said node has a directed edge of said plurality of edges from said node P; and
adding a node Q of said plurality of out-neighbors to said open-out-nodes, wherein said node Q has not yet been processed, an EW of a node Q peak structure of said plurality of node peak structures associated with said node Q is a sum of said node P edge weight and an EW of said node Q peak structure, a PL of said node Q peak structure is one more than said node P path length, and a PT of said node Q peak structure includes said node P path and said node P identifier.
